(19) United States
(12) Patent Application Publication
(10) Pub. No.: US 2013/0152174 A1
(43) Pub. Date: Jun. 13, 2013

(54) METHOD, APPARATUS, AND COMPUTER-READABLE MEDIUM FOR CONTENT ACCESS AUTHORIZATION

(71) Applicant: CONTENTGUARD HOLDINGS, INC., Wilmington, DE (US)

(72) Inventors: Michael Raley, Downey, CA (US); Eddie J. Chen, Rancho Palos Verdes, CA (US)

(73) Assignee: CONTENTGUARD HOLDINGS, INC., Wilmington, DE (US)

(21) Appl. No.: 13/764,589

(22) Filed: Feb. 11, 2013

Related U.S. Application Data
(63) Continuation of application No. 13/763,002, filed on Feb. 8, 2013.
Application No. 13/763,002 is a continuation-in-part of application No. 10/990,755, filed on Nov. 18, 2004.
(60) Provisional application No. 61/597,679, filed on Feb. 10, 2012.

(51) Int. Cl. H04L 29/06

(52) U.S. Cl. CPC H04L 63/10
USPC 726/4

(57) ABSTRACT

An apparatus, computer-readable medium, and computer-implemented method for obtaining access to content are disclosed. The method includes transmitting user credentials associated with a user of a device, the device having authorization to access content in a first content domain, and receiving temporary authorization for the device to access content in a second content domain based at least in part on a determination that the user associated with the user credentials has a license to access content in the second content domain.

### RELATED APPLICATION DATA

This application claims priority to U.S. Provisional Application No. 61/597,679 filed Feb. 10, 2012, and is a Continuation of co-pending U.S. patent application Ser. No. 13/763,002 filed on Feb. 8, 2013, which is a Continuation-in-Part of U.S. patent application Ser. No. 10/990,755 filed on Nov. 18, 2004, the disclosures of which are hereby incorporated herein by reference in their entirety.

### BACKGROUND

Recently, digital content distribution has seen reduced growth in unidirectional broadcast delivery and a downward trend in delivery via physical media such as CDs, DVDs, and the like. The trend is towards transmission via bidirectional wired and wireless networks in-part because users have more devices in more places than ever before and want to access content whenever and wherever they are on whatever device is most convenient at the time. Even popular traditional Direct to Home broadcast content delivery schemes such as satellite and cable (collectively “DTH”) have had to develop larger back channels to support a more rich, interactive, on-demand experience for users. Music too has seen a growth trend of interactive services replacing traditional radio.

The current trend in Video on Demand (“VOD”) service has pushed service providers to move towards streaming scenarios where content is delivered just-in-time and content protection is simplified because only transient and partial copies of high-value content are stored locally. Such scenarios help service providers deliver content across multiple types of devices because each stream can be tailored by the server to each device in response to each individual request.

However, current streaming services suffer from a number of drawbacks. Many streaming content distribution systems have proprietary Digital Rights Management (“DRM”) schemes that are only compatible with certain approved devices. Such “walled gardens” suffer from device incompatibility, limited sources of content, and reduced benefits of market competition. As a result, users who are locked into such a walled garden are unable to share content in a convenient manner or to take content from the walled garden and move to a different system.

Another drawback of current streaming services is authorization of only a limited number of devices at one time. For example, many services collect device ID information on a server or place a token in a cache on the local device in order to authorize the device to view content. Such implementations of device authorization place burdensome management tasks upon the user to manage a limited set of authorizations. Furthermore, it is the state of the art to only allow a single user log-in at one time. If a user logs-in to a second device, the first device is deauthorized.

Known authorization mechanisms require users to actively manage device deauthorizations. Some systems have a limited number of authorizations per account at any one time but an unlimited number of deauthorizations and new authorizations are allowed. In other systems the number of deauthorizations are limited to, for example, a few per year.

Additionally, in many existing DRM schemes, when moving a device from one domain to another, all the old content from the first domain must be removed or remain inaccessible while the device is authorized to the second domain. For example, the iTunes™ movie rental scheme will allow the movie to be played on up to 5 computers associated with the user's domain but when one of the devices is associated with another domain, the content from the first domain is made inaccessible. Such a scheme limits users experience beyond the limitations imposed by physical media. For example, when a user receives a CD, the user does not lose access to content that came from the user's own domain.

Therefore, improvements in authorization technology are needed which allow users to access content from multiple domains on multiple devices without having to manually manage authorization of devices.

### BRIEF SUMMARY

The disclosed embodiment relates to an exemplary method for granting access to content, including receiving user credentials associated with a user from a device, wherein the device has authorization to access content in a first content domain, determining whether the user associated with the user credentials has a license to access content in a second content domain, and granting temporary authorization to the device to access content in the second content domain based at least in part on a determination that the user associated with the user credentials has a license to access content in the second content domain.

The method can also include granting temporary authorization to one or more additional devices which are on the same network as the device, the temporary authorization allowing the one or more additional devices to access content in the second content domain.

The temporary authorization can automatically expire on the occurrence of one or more preset conditions, including the passage of a predetermined period of time, which can be defined by the user. The preset conditions can include accessing an item of content in the second content domain, the user moving outside of a predetermined distance from the device.

The temporary authorization can grant the device access to a subset of the content in the second content domain. Additionally, the method can include transmitting an offer to convert the temporary authorization to a permanent authorization. The temporary authorization can be granted depending on one or more conditions. For example, the temporary authorization can be not granted if the device has an active prior temporary authorization.

The first content domain can be accessible to the device based on a license belonging to a user other than the user associated with the user credentials.

User credentials can be received in response to a request for credentials sent to the device after an attempt to access an item of content that is in the second content domain and not in the first content domain. Additionally, the temporary authorization can be limited to the item of content that is in the second content domain and not in the first content domain and granting temporary authorization to the device can include transmitting a temporary domain key to the device.

While the device has temporary authorization to access content in the second content domain, the device can have authorization to access content in both the first content domain and the second content domain. Alternatively, while the device has temporary authorization to access content in the second content domain, the authorization of the device to access content in the first content domain can be suspended.

The disclosed embodiment also relates to an exemplary method for obtaining access to content, including transmitting user credentials associated with a user of a device, wherein the device has authorization to access content in a first content domain, and receiving temporary authorization for the device to access content in a second content domain based at least in part on a determination that the user associated with the user credentials has a license to access content in the second content domain.

The exemplary method can also include receiving temporary authorization to one or more additional devices which are on the same network as the device, the temporary authorization allowing the one or more additional devices to access content in the second content domain.

Temporary authorization can automatically expire on the occurrence of one or more preset conditions, including the passage of a predetermined period of time, which can be defined by the user. The preset conditions can include accessing an item of content in the second content domain, the user moving outside of a predetermined distance from the device.

The temporary authorization can grant the device access to a subset of the content in the second content domain. Additionally, the method can include receiving an offer to convert the temporary authorization to a permanent authorization. The temporary authorization can be granted depending on one or more conditions. For example, the temporary authorization can be not granted if the device has an active prior temporary authorization.

The first content domain can be accessible to the device based on a license belonging to a user other than the user associated with the user credentials.

User credentials can be transmitted in response to a request for credentials received by the device after an attempt to access an item of content that is in the second content domain and not in the first content domain. Additionally, the temporary authorization can be limited to the item of content that is in the second content domain and not in the first content domain and granting temporary authorization to the device can include transmitting a temporary domain key to the device.

While the device has temporary authorization to access content in the second content domain, the device can have authorization to access content in both the first content domain and the second content domain. Alternatively, while the device has temporary authorization to access content in the second content domain, the authorization of the device to access content in the first content domain can be suspended.

The disclosed embodiment further relates to an exemplary method for granting access to content, including receiving user credentials from a first device at one or more computing devices, wherein at least one of the one or more computing devices manages access to content stored on a content storage device, the content being in a content domain, wherein the first device and the content storage device are locally connected, determining whether a user associated with the user credentials has a license to access content in the content domain on a second device, and granting temporary authorization to the first device to access content in the content domain based at least in part on a determination that the user associated with the user credentials has a license to access content in the content domain on the second device.

The temporary authorization can automatically expire on the occurrence of one or more preset conditions. The one or more preset conditions can include the passage of a predetermined period of time, accessing an item of content in the content domain, and/or the first device moving outside of a predetermined distance from the content storage device.

The temporary authorization can grant the first device access to a subset of the content in the content domain and granting temporary authorization to the first device can comprise transmitting a temporary domain key to the first device.

The disclosed embodiment also relates to an exemplary method for obtaining access to content, including transmitting user credentials from a first device to at least one of one or more computing devices, wherein at least one of the one or more computing devices manages access to content stored on a content storage device, the content being in a content domain, and wherein the first device and the content storage device are locally connected, and receiving temporary authorization for the first device to access content in the content domain based at least in part on a determination that a user associated with the user credentials has a license to access content in the content domain on a second device separate from the first device.

The temporary authorization can automatically expire on the occurrence of one or more preset conditions. The one or more preset conditions can include the passage of a predetermined period of time, accessing an item of content in the content domain, and/or the first device moving outside of a predetermined distance from the content storage device.

The received temporary authorization can grant the first device access to a subset of the content in the content domain and granting temporary authorization to the first device can comprise transmitting a temporary domain key to the first device.

The disclosed embodiment further relates to an exemplary method for obtaining access to content, including receiving content in a content domain, wherein the user does not have a license for the content in the content domain and is therefore unable to access the content, transmitting information indicating that the user desires to access the content in the content domain for which the user does not have a license, and receiving a temporary authorization which allows the user to access the content in the content domain until the expiration of the temporary authorization.

The content and the temporary authorization can be received from the same computing system or can be received from different computing systems. The content can be received upon the occurrence of one or more conditions, such as the user being within a predetermined distance of a computing system that hosts the content, the user requesting to download the content, and/or the user being subscribed to receive the content.

The information indicating that the user desires to access the content can be transmitted in response to receiving an offer to access the content, and the content and the offer to access the content can be received from two different computing systems.

The temporary authorization can automatically expire on the occurrence of one or more preset conditions, such as the passage of a predetermined period of time and/or accessing an item of content in the content domain.

The disclosed embodiment also relates to an exemplary method for granting access to content, including receiving information indicating that a user desires to access downloaded content stored on a user device, wherein the content is in a content domain, and wherein the user does not have a license for the content in the content domain and is therefore unable to access the content, and transmitting a temporary authorization to the user device which allows the user to access the content in the content domain on the user device until the expiration of the temporary authorization.

The content can be downloaded from the same computing system that transmits the temporary authorization or from a different computing system than the computing system that transmits the temporary authorization. The content can be downloaded upon the occurrence of one or more conditions, such as the user device being within a predetermined distance of a computing system that hosts the content, the user requesting to download the content, and/or the user being subscribed to receive the content.

The information indicating that a user desires to access downloaded content can be received in response to transmitting an offer to access the content to the user device and the content can be downloaded from a different computing system than the computing system that transmits the offer.

The temporary authorization can automatically expire on the occurrence of one or more preset conditions, such as the passage of a predetermined period of time and/or accessing an item of content in the content domain.

The disclosed embodiment further relates to an exemplary method for viewing content, including storing data corresponding to a first content domain associated with a first user and a second content domain associated with a second user, wherein a device has authorization to access content in the first content domain and temporary authorization to access one or more items of content in the second content domain, and displaying content indicators associated with each item of content in the first content domain and the one or more items of content in the second content domain, wherein the content indicators associated with the one or more items of content in the second content domain include information identifying the one or more items as being in the second content domain.

The temporary authorization can automatically expire on the occurrence of one or more preset conditions, including the passage of a predetermined period of time and/or accessing an item of content in the second content domain.

The first user and the second user can both users of the device, and the content in the first domain and the second domain can be stored on the device. The information identifying the one or more items as being in the second content domain can include information identifying the second user. Additionally, the first user and the second user can be the same user.

The steps of the above methods can be executed by one or more computing devices. The disclosed embodiment also relates to exemplary devices or apparatus having, for example, one or more processors, and one or more memories operatively coupled to at least one of the one or more processors and having instructions stored thereon that, when executed by at least one of the one or more processors, cause at least one of the one or more processors to execute the steps of any of the above-mentioned exemplary methods. The disclosed embodiment further relates to exemplary non-transitory computer-readable media storing computer-readable instructions that, when executed by one or more computing devices, cause at least one of the one or more computing devices to perform the steps of the above-mentioned exemplary methods.

### BRIEF DESCRIPTION OF THE DRAWINGS

FIG. 1A is a flowchart of an exemplary method of granting temporary authorization to a device according to a disclosed embodiment.

FIG. 1B is a flowchart of an exemplary method of requesting user credentials to grant temporary authorization to a device according to a disclosed embodiment.

FIG. 2A is a diagram showing the content domains of two different users.

FIG. 2B is a diagram showing the content domains of two different users when one user has obtained temporary authorization to access the content domain of the other user according to a disclosed embodiment.

FIG. 3 illustrates an exemplary method of temporary device authorization where a first user enters valid credentials into a device having an authorization for a second user according to a disclosed embodiment.

FIG. 4A provides a flowchart of an exemplary method for temporarily authorizing a device as a member of a domain of authorized devices in response to a request for an item with associated usage rights according to a disclosed embodiment.

FIG. 4B provides a flowchart of an exemplary method for enforcing a time condition for a temporary authorization according to a disclosed embodiment.

FIG. 5 illustrates the interaction of a non-domain device with two DRM systems according to a disclosed embodiment.

FIGS. 6A-6C illustrate the operation of temporary authorization for multiple devices having concurrent membership in more than one domain according to a disclosed embodiment.

FIGS. 7A-7F illustrate exemplary user interfaces that can be utilized with the temporary authorization method according to a disclosed embodiment.

FIG. 8 illustrates one system of trust that can be used for temporary authorizations according to a disclosed embodiment.

FIG. 9 illustrates a system of trust with domain keys and content keys that can be used for temporary authorizations according to a disclosed embodiment.

FIG. 10 illustrates an exemplary computing environment that can be used to carry out the method of temporary authorizations according to a disclosed embodiment.

### DETAILED DESCRIPTION

While methods, apparatuses, and computer-readable media are described herein by way of examples and embodiments, those skilled in the art recognize that methods, apparatuses, and computer-readable media are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

There is a need for technology which allows users to participate in several domains (walled gardens) at the same time and yet avoids the restrictions associated with typical domain memberships while providing protection to authors against misappropriation of digital media. What is needed is a user experience where content is not restricted to a limited number of devices, but provided to nearly any device, if only on a temporary basis, and which works to protect rights owners. Furthermore, what is needed is a way to reduce the burden on users of having to manage device authorizations without restricting users to a limited set of devices or a single user log-in at one time. Additionally, what is needed is a system for convenient device authorization across a plethora of devices such that management responsibilities are reduced and/or automated and device authorizations are nearly unlimited, at least for temporary time periods, thereby providing a more convenient user experience.

The disclosed method and system improves upon discrete device limitations by introducing the concept of “temporary” authorizations. An embodiment of a content system can grant a temporary authorization to whatever device is available to a user based upon the user's account credentials.

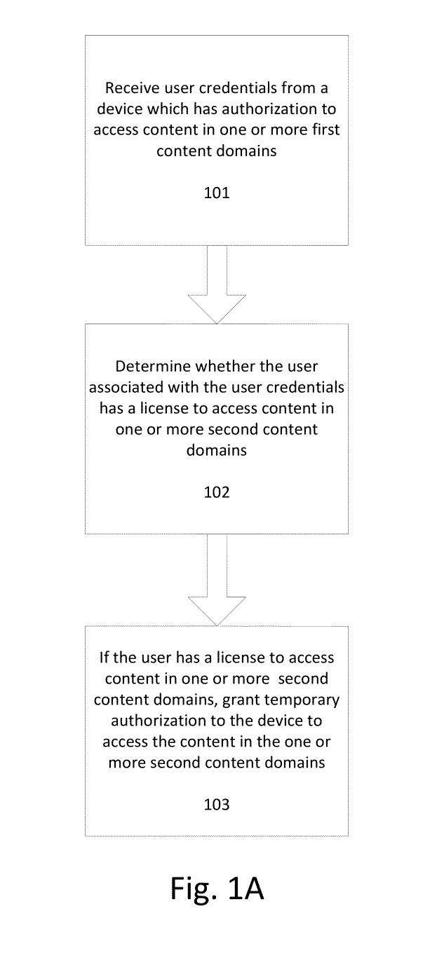

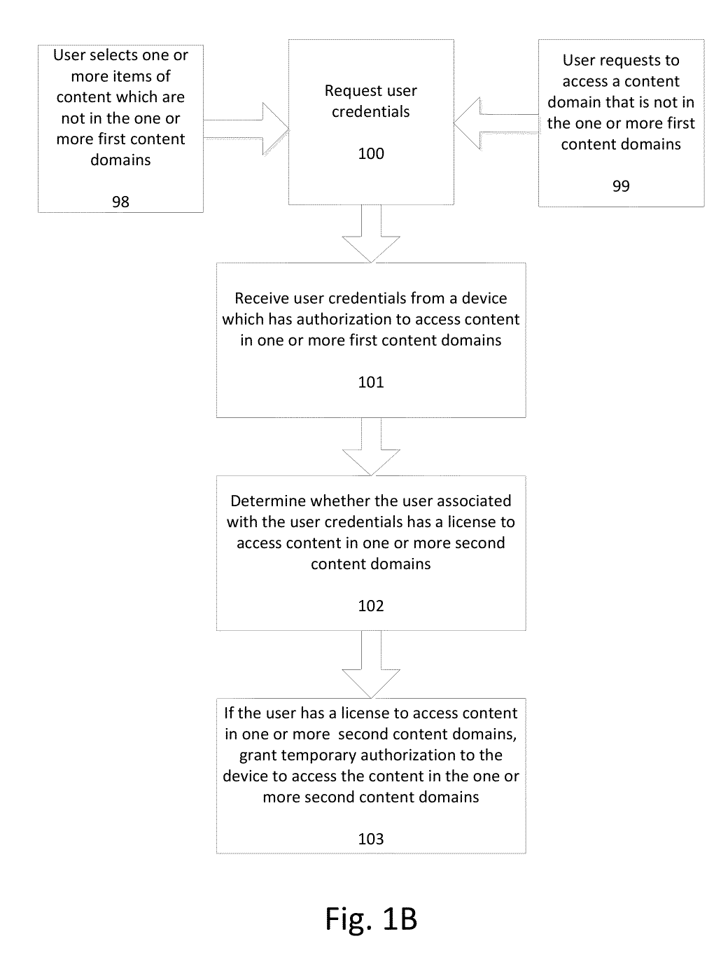

With reference to FIG. 1A, an overview of the method according to an exemplary embodiment is shown. At step 101, user credentials are received at an authorizer computing system from a device which has authorization to access content in one or more first content domains. The user credentials can be input through any input means. For example, if the device is a computer, the user can use a keyboard or mouse. If the device is a set top box (“STB”) or a TV, the user can input the credentials via remote control, voice commands, gestures, or any other suitable interface mechanism.

Optionally, the user credentials can be received at a device which does not have authorization to access content in any content domains. A user can wish to view content for which they have a license on a different device than the devices which are authorized to access the content. For example, the user can wish to access premium cable TV content on their mobile device or laptop. In this case, the mobile device or laptop can be without authorization to access any content domains.

A content domain can be the content that is available to one or more users who are subscribed to, or otherwise have access to, a particular set of content. For example, a content domain can be considered to be the content that is available to someone with a cable TV subscription, a premium channel subscription, a right to access a paper view event, a subscription to a streaming service such as Netflix™, a sports pass such as NFL Sunday Ticket™, a particular music or video library, and the like. A domain can include a library of content that is available to someone with a particular device, for example, the Kindle™ owners' lending library. A domain need not be limited to associating a limited number of devices to a user account. A domain can represent any association or restriction of devices, content, applications and the like with a user or user account. Furthermore, a particular domain can even have more than one user, for example, a family or group content domain which includes all the content available to a group of persons.

At step 102, the authorizer computing system determines whether the user associated with the user credentials has a license to access content in one or more second content domains, outside of the one or more first content domains which the device already has authorization to access content.

If the user does have a license to access content in one or more second content domains, the authorizer computing system grants a temporary authorization to the device at step 103. The temporary authorization can implemented in various ways (discussed further below), and allows the device to access content in the one or more second content domains according to the conditions of the temporary authorization.

The temporary authorization can extend to one or more items of content in the one or more second content domains for which the user has a license. For example, the temporary authorization can be limited to a single item of content, such as a particular movie, or a group of content within a content domain, such as a television series, or can even be used to access all content in the one or more second content domains.

The temporary authorization can be for a preset duration, such as 1 day or 1 week, based on the specific content domain or content item which is being authorized. For example, a content provider can specify that any temporary authorizations granted for their content can only be for maximum 48 hour duration. Alternatively, or additionally, the user can specify the duration of the temporary authorization, such as by inputting the duration after the temporary authorization has been granted or when providing their credentials. The temporary authorization can also be based on the number of views, so that after a certain number of views, the authorization automatically expires. For example, a temporary authorization for a television series can allow the device to access six episodes of the series. The temporary authorization can also be set to expire after one view, such as for a movie or sports event. The temporary authorization can be associated with preset conditions. The preset conditions can be set by the content provider, the content owner, or the temporary authorization requester. For example, certain content providers can stipulate that temporary authorizations for one of their content items must expire halfway through playback of the content item, so that a user must acquire a non-temporary authorization to continue watching. The temporary authorization can also expire without any further action by the user. Many variations are possible, and these examples are not intended to be limiting.

Additionally, the temporary authorization can extend to one or more additional devices that are on the same network as the requesting device. For example, a guest can enter their credentials into a friend's STB and receive a temporary authorization for that device to play the guest's content. Additionally, the temporary authorization can extend to other STBs or devices on the same network. So that if another user in the home wishes to view the guest's content on their mobile phone, for example, the mobile phone can connect to the house network and receive a temporary authorization.

The temporary authorization can also extend to one or more additional devices based on GPS tracking and/or location coordinates of the license owner. For example, a license owner who has access to content in a first content domain can procure temporary authorization for devices within 20 feet of their mobile device. If this license owner travels to a friend's house, all of the friend's devices within 20 feet of the license owner's mobile device can be temporarily authorized. Of course, this example is provided for illustration only, and the radius for temporary authorization can be greater or less than 20 feet and can be based on any kind of tracking device or permanent location (such as the address of the friend's home and the dimensions of the home).

The temporary authorization can optionally be associated with a fee, surcharge, or other condition; such that the authorization is not granted until the condition is satisfied. Alternatively, a fee or surcharge can be assessed once the temporary authorization expires, if a user of the device wishes to continue accessing the content from the one or more second content domains on the device. For example, a user at a friend's house can enter their credentials into a friend's STB in order to gain temporary authorization to access content that the user has access to but the friend does not. After the temporary authorization expires, the friend can optionally procure indefinite or permanent authorization for the content in the one or more second content domains associated with the user for a fee. A user can also request or choose from temporary authorizations with different preset conditions at different price points. For example, a temporary authorization with a preset duration of 1 day can cost less than a temporary authorization with a preset duration of 1 week. Many variations are possible.

Additionally, the number of total temporary authorizations, temporary authorizations within a specific time period, or concurrent temporary authorizations can be limited. The limits can be imposed based on either the device for which temporary authorization is sought, or the user associated with the user credentials who is requesting the temporary authorization. For example, the authorizer computing system can limit the number of temporary authorizations to one temporary authorization per device at any given time. Therefore, in order to activate a new temporary authorization on a particular device, the user would have to deactivate any prior temporary authorizations. Additionally, the number of temporary authorizations that can be requested can be limited to a certain number per month per user. For example, a user can request temporary authorization for up to three unauthorized devices per month. Many variations are possible, and these examples are not intended to be limiting.

Referring now to FIG. 1B, different ways in which the user credentials can be requested are now discussed. At step 98, the user can request access to content which is not in the one or more first content domains for which the device is authorized. In response to the request, the authorizer computing system can request that the user enter their credentials at step 100.

Alternatively, at step 99, the user can request access to one or more second content domains which they know to be outside the access authorization of the device. In the example of the user going to their friend's house, the user can select an option through an input device or interface which is designed to allow them to access their own library. For example, a “guest library” button, or other interface element, can be part of the VOD or streaming services, and by selecting the “guest library” button, the user can be prompted to enter their credentials so that they can obtain temporary authorization on the device to access their own library.

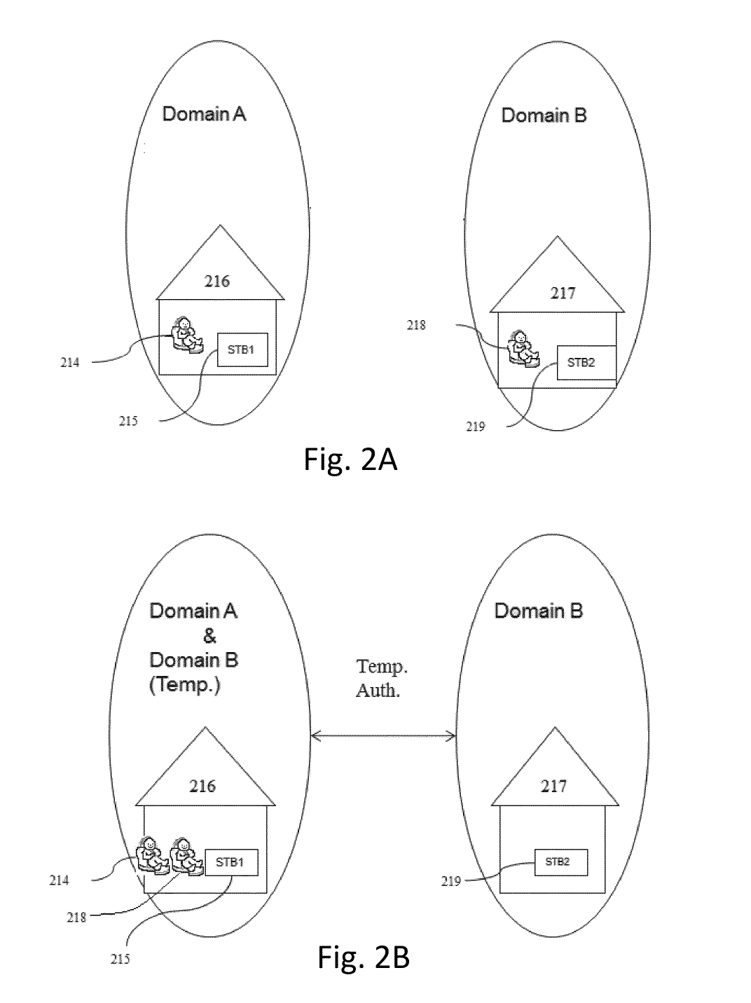

Referring to FIGS. 2A-2B, an example of temporary authorizations is illustrated in the context of set-top cable boxes. FIG. 2A shows a first user 214 that has access to a content domain, Domain A, in their home 216 through the use of a STB 215. A second user 218 has access to a content domain, Domain B, in their home 217 through the use of a STB 219.

As shown in in FIG. 2B, the second user 218 can go over to the first user's home 216 and enter their credentials into the first user's STB 215 in order to access the content which they have access to through their own STB 219. Using the disclosed temporary authorization technology, STB 215 would then have access to the content in Domain B under a temporary authorization, as well as the content that is normally available in Domain A. Of course, content domains corresponding to more than two users can also be accessed on a single device through the use of temporary authorizations. Additionally the temporary domains can optionally replace the non-temporary domains, or can coexist with the non-temporary domains.

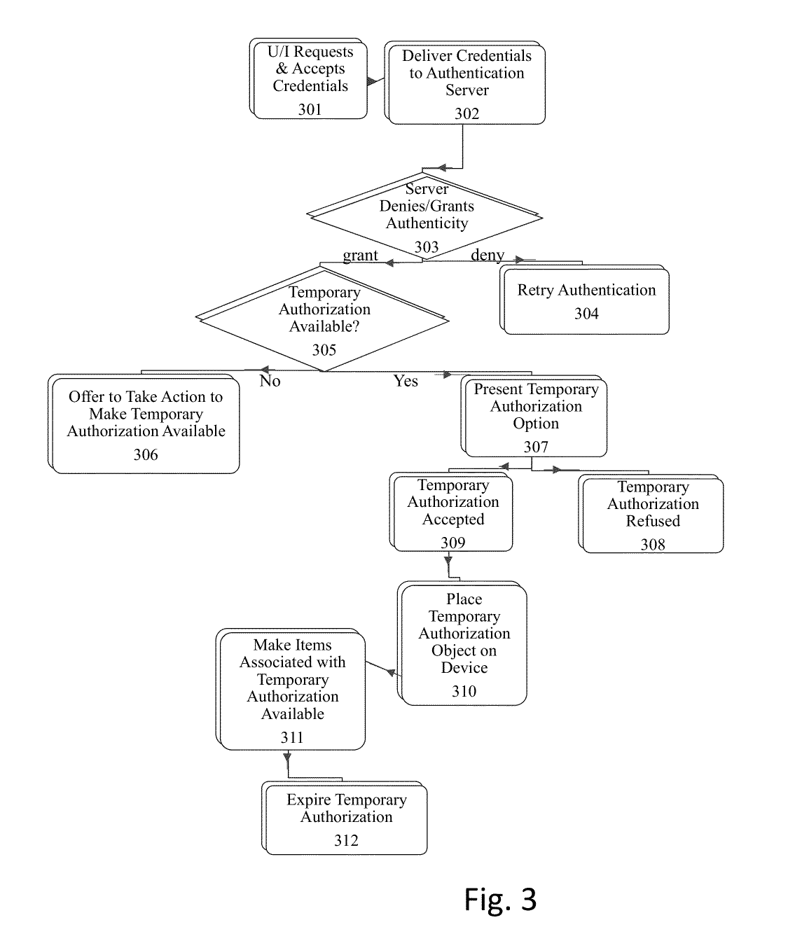

FIG. 3 shows an example process that can be used for temporarily authorizing content objects on a device authorized to access content in a first content domain associated with a first user, according to a disclosed embodiment. At step 301, a second user can enter their credentials, associated with a second content domain, into a user interface (“UI”) of the device which is authorized for the first user and the first content domain. As discussed earlier, these credentials can be requested through the UI or can be volunteered by the second user.

At step 302, the device delivers the credentials to an authentication server, which can be part of the authorizer computing system, or can alternatively be a third party authentication server in communication with the authorizer computing system. The server can deny or grant authenticity at step 303. Alternatively, the authentication information can be provided back to the device, which itself can make a grant or deny decision. If the authentication is denied, the authentication process can be retried at step 304 by informing the user that the authentication failed and repeating the initial steps.

Otherwise, the authorizer computing system determines whether temporary authorization is available at step 305. The temporary authorization availability can be verified with a domain authorization server associated with the second content domain. However, temporary authorizations can also be created and managed by authorizer computing system. The temporary authorization can be unavailable based on a variety of restrictions that can be implemented, as discussed earlier. For example, the authorization can be unavailable because the second user has exceeded their quota of concurrent temporary authorizations, or their quota of temporary authorizations in a month, or already has a temporary authorization active and is not allowed to activate another one at the same time. Additionally, the temporary authorization can be unavailable due to rules associated with one or more content providers in the second content domain, such as limitations on which devices can activate a temporary authorization, or times of the month when users can activate temporary authorizations.

If temporary authorization is not available, the authorizer computing system can produce a number of possible responses at step 306 to try to make temporary authorization available. For example, the authorizer computing system can transmit a message to the user offering to revoke an outstanding temporary authorization, thus making a temporary authorization available. Alternatively, the authorizer computing system can authenticate the device with non-temporary authorization, refuse to authorize the device, or perform any other suitable response.

If a temporary authorization is available, the UI can present the temporary authorization option to the second user at step 307. The system can provide for a customization opportunity at this point. For example, the UI can offer to set the amount of time the authorization lasts, or adjust or restrict the rights granted via the temporary authorization or similar customizations.

The second user can decline the temporary authorization at step 308 or accept at step 309. If the temporary authorization is accepted, a temporary authorization object can be placed on the device at step 310, causing the device to temporarily have access to the benefits and features of the domain such as content, applications and the like at step 311. Additionally, the domain server and/or authorizer computing system can be updated to reflect the addition of the device, temporarily, to the domain and of the temporary authorization activation by the second user.

Once the conditions associated with the temporary authorization have been fulfilled, the temporary authorization expires at step 312, making the benefits and features associated with the domain unavailable to the device. For example, after a certain period of time associated with the temporary authorization, or a certain number of views, the temporary authorization can automatically expire. Additionally, the domain server and/or authorizer computing system can update to reflect the availability of a temporary domain authorization for the second user.

Temporary authorizations are not limited to devices that are already authorized to access a particular content domain. Temporary authorizations can also be utilized with devices that are not currently authorized for any content domains.

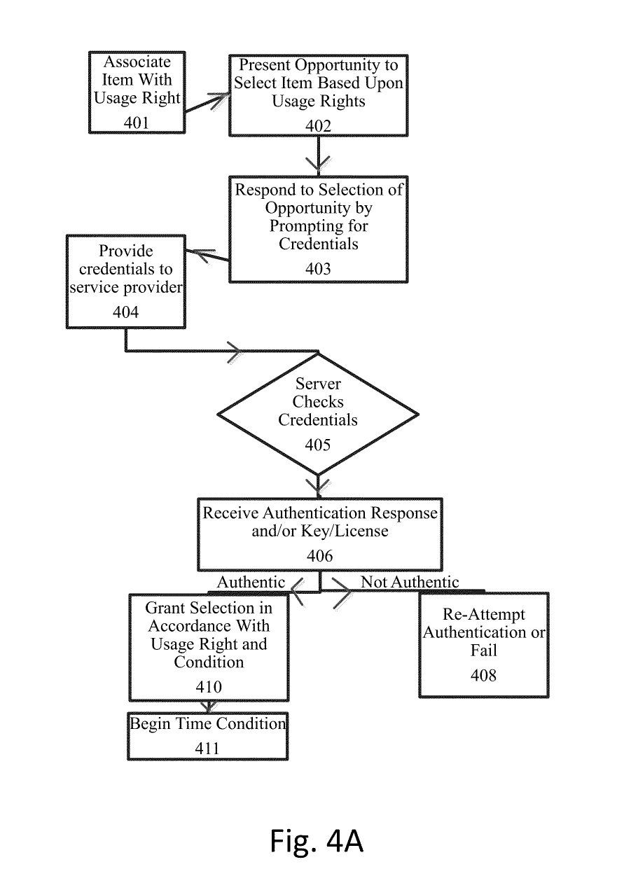

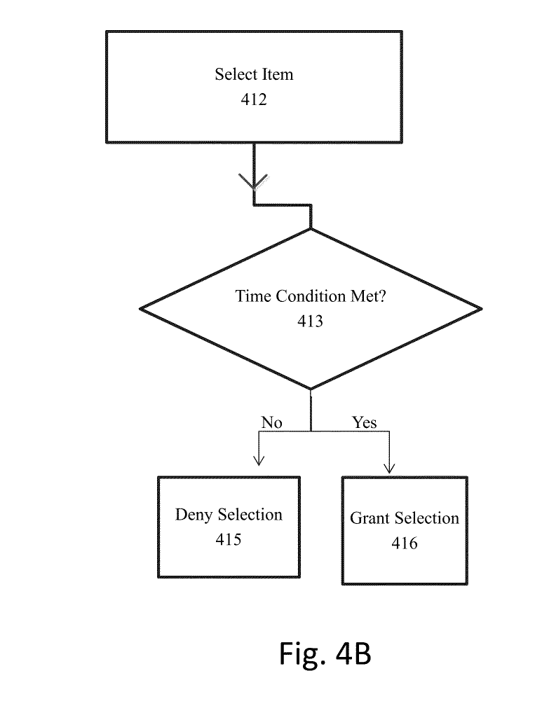

For example, FIGS. 4A-4B provide an outline of exemplary steps for temporarily authorizing a device as a member of a domain of authorized devices in response to a request for an item that has associated usage rights. In step 401 an item is associated with a usage right. Such association can be performed by a service provider using a rights editor or the like. Alternatively the association can be performed by a third party before the item is delivered to the service provider. Alternatively, usage rights are associated with content based upon the user's selection of the content. For example, an item icon can present the option to rent or buy the item. If the buy option is selected, usage rights appropriate for a buy transaction are associated with the content using, for example, a license. If the rent option is selected, usage rights appropriate with a rental are associated with the content. In step 402, a user is presented with an opportunity to select an item. Usage rights associated with the item can determine, for example, if the item appears as a catalog entry at all, or alternatively usage rights can determine what actions are available upon selection of the item.

The response to selection of an item can result in a prompt for credentials 403. The user can then provide credentials to a service provider in step 404 and the service provider can check the credentials for authenticity in step 405. The service provider that checks the credentials can be the same as the service provider of the content. Alternatively, the service provider that checks the credentials can be a different service provider from the service provider that provides the content. Such a scheme can rely upon a federated authentication scheme such as Higgins, Windows Cardspace, SAML, MicrolD and OpenID or the like. After the server checks the credentials, a response indicating whether the credentials are authentic or not is received 406 at the device. Optionally, the response can include data such as a key or license.

If the authentication credentials are not authentic the selection can fail or authentication can be attempted over again in step 408. If the authentication credentials are authentic the device can grant the selection in step 410 in accordance with the associated usage rights and any conditions, if applicable. Valid authentication credentials can result in a temporary authorization restricted to the specific item associated with the selection or can result in a temporary authorization to the entire domain. Temporary authorizations can be restricted by relatively short time conditions or other suitable conditions, such as location or events, which can be automated and/or manually controlled through device management interfaces. By contrast, non-temporary authorizations have the characteristics of relatively longer term persistence and heavier management costs in the form of manual deauthorizations and restrictions on the number of deauthorizations over some time period.

The device can use proof of authentication to access associated usage rights stored remotely with a service provider to grant the request tied to the requested item. Alternatively, the device can use the validity of the credentials to access a service provider that provides the device with content associated with the item selection. Additionally, an authorized device can rely upon a locally stored license and locally stored content to grant the selection.

A temporarily authorized device can begin tracking a time condition associated with the temporary authorization in step 411. Alternatively, a service provider can track the temporary authorization via centralized or distributed repositories. In either case, a time-based temporary authorization will automatically lapse once the time limit is reached, resulting in a revoked authorization. A time condition associated with an authorization can be checked in step 413 in response to item selection in step 412. If the time condition is not met then the selection is denied in step 415. If the time condition is met the selection can be granted in step 416. Additionally, the authorization can be checked in response to item selection and selection is granted or denied if the device is authorized or not authorized respectively. Additional criteria detailed in the usage rights can also be required along with the authorization or time condition before granting the selection.

Temporary authorizations can be used in conjunction with local network media servers to reduce broadband consumption of network resources. An increased growth in file sharing and content streaming services is placing new burdens on transmission networks. For example network traffic is more commonly being controlled by service providers charging by the bit. The present system can be used to offset the high costs associated with such consumption. Media servers can store thousands of files of preloaded protected content. These servers can be located in high traffic areas and can optionally be updated via a network connection. Consumers can then interact with such servers over a local wired or wireless connection to obtain rights to the content on the server without using costly per bit data rate plans.

There are many ways of placing content nearer to consumers. The consumer can obtain a temporary authorization to a content domain on a server. The temporary authorization can be to some subset or all of the content located on the server and can provide for temporary download to the consumers device. The consumer's device can obtain a temporary authorization to such a server placed on an airplane, for example, and the content can be provided via LAN or Wi-Fi, for example. The server can then utilize a WAN or broadband connection only for the purpose of verifying the user's credentials and verifying that the user has the rights to access a particular piece of content or a content domain on one or more second devices. Such a system provides the immediate gratification and selection of a streaming VOD system while avoiding the pitfalls associated with the high volume of broadband usage required by a typical VOD system.

A server can be a kiosk, located in a retail store or at a service station along a highway, for example. Consumers can interact with the server to obtain a copy of content and/or receive temporary authorization to access a catalog of options that are all downloaded over a local connection to the consumer's device, such as a phone or in-car entertainment system. In an exemplary scenario, the consumer can purchase and obtain a temporary authorization to the content on the server. The temporary authorization can then be placed on the consumer's device along with the content. Such a system can also support the scenario where protected content is pushed to the consumer device prospectively in the anticipation of a purchase. Such a device can support a domain manager and a purchase manager that controls access to the protected content and conducts financial transactions.

Using temporary authorization technology, wireless-enabled (e.g. Wi-Fi) storage devices (WESD) can be used to advertise vast stores of content. Such devices can be situated in airports or airplanes or as part of an in-car entertainment system for example. The content can be made available for purchase or rental outright or can be available via rights that were obtained prior to interaction with the WESD, such as via subscription. Access to the content can also be granted via a temporary domain membership with the WESD where all or some subset of the content becomes available for a limited period of time. For example, the WESD can be part of an in-car entertainment system and occupants can access the content via tablet or smart phone through the local wireless connection instead of obtaining content over a 3G network for example. Such a system can allow an occupant with a domain authorization to temporarily share the content of the WESD with the other occupants of the vehicle through temporary authorization of the other occupants' devices.

Content for which the user does not have any access rights can be transmitted to one or more user devices. The content can be in a content domain for which a user does not have a license and can be downloaded to a user device, either at the request of the user, pursuant to some subscription agreement, or automatically without any actions or input from the user. Additionally, the content can be downloaded based on one or more conditions, such as proximity of the user device to a content storage device, or some other condition. When the user wishes to access the content, he or she can submit a request to an authorization server or other authorizer computing system. Alternatively, the user can be asked whether they would like to access the content stored on their device, to which they can respond in the affirmative. Regardless of how the user indicates that they would like to access the content, the authorization computing system can respond to the indication by activating a temporary authorization which was bundled with the content or by transmitting a temporary authorization to the user device, if the content was previously transmitted without the temporary authorization. This temporary authorization can allow the user to access the content stored on their device until the expiration of the temporary authorization.

This system can be implemented in a variety of situations when the user does not always have access to the internet or mobile communications networks. For example, when a user is within range of a content repository at the airport, content can be downloaded to the user's device. Prior to take-off, the user can be asked whether they wish to access the content that was downloaded to their device. If the user responds that they would, the user device can be temporarily authorized so that the user can access the content until the expiration of the temporary authorization, even while the plane is in the air and the device is offline. Alternatively, the temporary authorization can be bundled with the content so that it can be activated when the device is offline. For example, the device can detect that the user's device is out of network contact and then present an advertisement to the user asking whether they would like to watch content that has already been downloaded to their device.

Additionally, the computing system that transmits the content can be the same as, or different than the computing system which transmits the temporary authorization or offer to the access the content. For example, a content repository in the user's home can transmit content to the user's laptop computer. While on a business trip, a hotel computing system can detect that the user has protected content on their laptop for which they do not have a license. The hotel computing system can then transmit an offer to the user's laptop to grant the laptop temporary authorization to view the content that was received from the content repository in the user's home. Alternatively, the computing system that transmits the content can be the same computing system that provides the temporary authorization. For example, a user can automatically receive an electronic book on their electronic book reader from a bookstore computing system when entering a bookstore but be restricted from accessing the book. If the user desires to read a portion of the book, they can request temporary authorization and the bookstore computing system can temporarily authorize the electronic book reader to access the received book.

Using the example of a cable provider, cable companies can place a single smart device in customers' homes that hosts content and is able to interface with a variety of customer devices. The smart device can be similar to a kiosk or edge server, in that it hosts the content, which can be downloaded from the cable provider, and makes it available to all devices within the home. The smart device can automatically push the content to available devices and make temporary authorization available to the user devices to allow access to the content. Alternatively, customers can be able to view the content stored on the smart device and download the content to any of their devices at the same time that they obtain temporary or non-temporary authorization. The smart device can detect all the devices on a home network, such as a wireless network, or can allow for physical connections, such as USB connections. The content from the smart device can be requested by the customer from a customer device without obtaining the access rights to the content, so that the customer has the option of purchasing a temporary authorization at a later time without having to acquire the content on their device.

Temporary authorizations can be set to automatically expire based on the occurrence of one or more preset conditions. The conditions can include the passage of a predetermined period of time, the viewing or access of certain content, a predetermined number of viewings or accesses of the content, the movement of the user outside of a certain range, for example, the movement of the user a predetermined distance away from a WESD device, or the movement of a user a predetermined distance from the device granted the temporary authorization. Distances can be tracked using many known methods, such as GPS based tracking of mobile devices of users and other similar methods.

Additionally, temporary authorizations do not require an active connection in order to expire or track fulfillment of conditions, but can be activated or deactivated while offline. Using the example of the temporary authorization received prior to take-off, if the temporary authorization has an expiration condition of one viewing of the content, then the temporary authorization can expire after the user has completed viewing the content once, even if the device does not have an active internet connection at the time. After the device regains a network connection, it can update the appropriate monitoring server with the temporary authorization information.

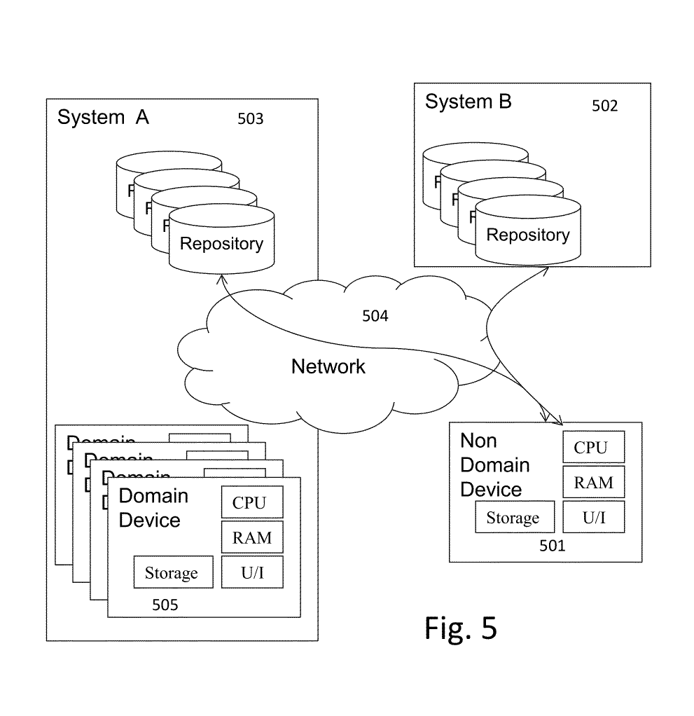

Temporary authorizations can be transferred across multiple DRM systems. FIG. 5 shows a non-domain device 501 that is not associated with any particular content domain, DRM System A 503, and DRM System B 502. System A 503 can be associated with a number of domain devices 505, whereas System B 502 is not tied to any domain restrictions. For example, DRM System A can be a premium cable channel DRM system that is associated with a number of STBs and DRM System B can be associated with a basic cable service DRM system. Of course, these systems are provided only to illustrate some possible DRM systems, and are not intended to be limiting.

The components of DRM System A 503, DRM System B 502 and device 501 communicate via network 504 which can be comprised of any combination of the Internet, WANs, LANs, cellular networks, or any suitable private or public, wired or wireless networks and the like. The communication can also occur via removable storage devices or via the devices themselves over local wireless communications such as Bluetooth or Wi-Fi (IEEE 802.11) and the like.

The non-domain device 501 can obtain a temporary authorization on its behalf with DRM System A 503 (via any of the disclosed methods) over the communication network 504. The temporary authorization can temporarily grant access to the entire domain of content or some subset thereof such as a single piece of content. However, such authorization does not necessarily require the device 501 to obtain the authorized content from DRM System A. Device 501 can also use evidence of the temporary authorization to content in DRM System A 503 to obtain an instance of the content from DRM System B 502. For example, device 501 can use a content license received from DRM System A 503 (as a result of the temporary authorization) to receive an instance of the content from DRM System B 502. Such a scenario is particularly useful when the device 501 has a high bandwidth connection tied to DRM System B 502 but does not ordinarily have authorization to the particular desired content.

Using the example of cable service, cable providers often link a broadband connection with their own particular content service. Cable providers often have tiers of access that users subscribe to as well. When a subscriber with a basic subscription (DRM System Basic) has a friend visit who has authorization to a premium content domain with content not found in the basic tier (DRM System Premium), the visitor can temporarily authorize the subscribers device to the visitors domain thus authorizing the subscribers device to both the cable providers content (DRM System Basic domain) and the visitors content (DRM System Premium domain). However, since the subscriber's connection to DRM System Basic is more suitable for receiving the premium content, the subscriber's device can use the license or authorization from DRM System Premium to access an instance of the content from DRM System Basic even though the subscriber does not normally have access to the premium content.

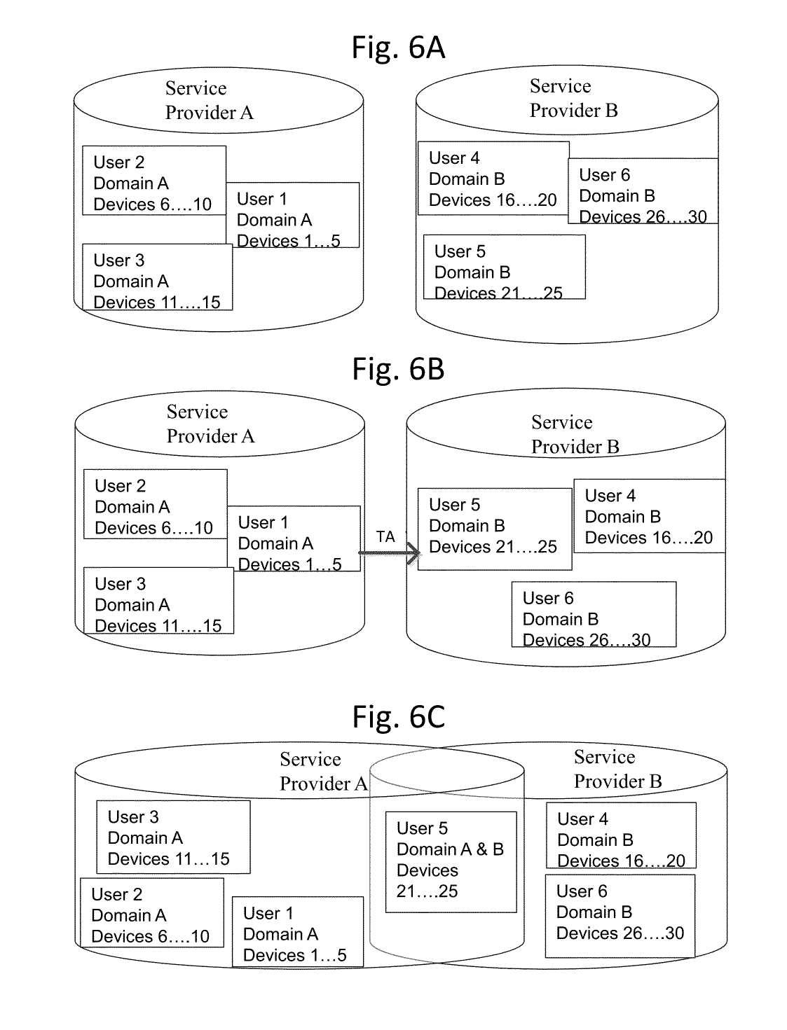

Multiple devices can have concurrent membership in more than one content domain. For example, referring to FIG. 6A, six users are shown in two different content domains. Users 1-3 are part of the content domain comprising Service Provider A, and Users 4-6 are part of the content domain comprising Service Provider B. Each of the users has multiple devices which are authorized to access the content in their content domain.

As shown in FIG. 6B, User 1 can provide a temporary authorization to User 5 which applies to all of the devices of User 5. This temporary authorization can be requested from any one of the devices of User 5, and when granted, automatically be propagated to other devices registered to User 5. Alternatively, the temporary authorization can be downloaded to removable storage drive, such as a USB, and then downloaded onto all the devices which User 5 wishes to expand the temporary authorization onto. The all-device temporary authorization can also be a special type of temporary authorization that is requested by User 1, such that when it is granted, the temporary authorization objects can be placed on all of the devices of User 5 substantially at the same time. Many variations are possible and these examples are not intended to be limiting.

FIG. 6C illustrates the domains to which User 5 has access after the temporary authorization is granted. In addition to User 5's original content domain of Service Provider B, User 5 can also access content in the domain of Service Provider A on all of their devices, devices 21 through 25. The accessible content can be organized by the authorization type. For example, User 5 can browse one folder containing all the content which is temporarily authorized alongside another folder for content for which User 5 has non-temporary authorization.

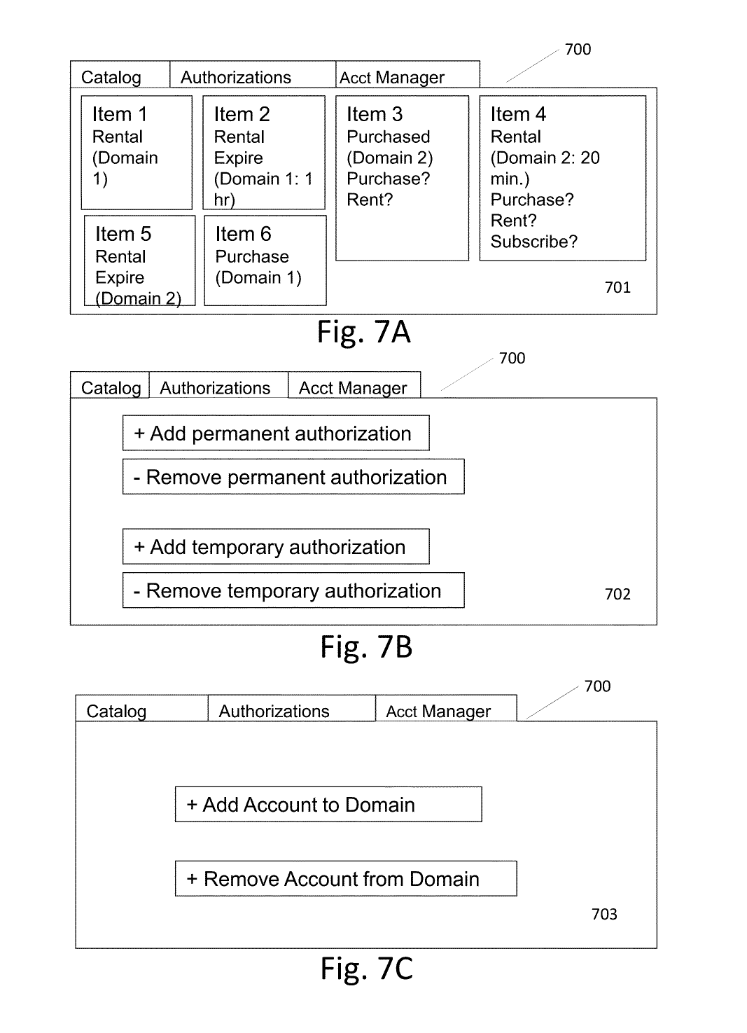

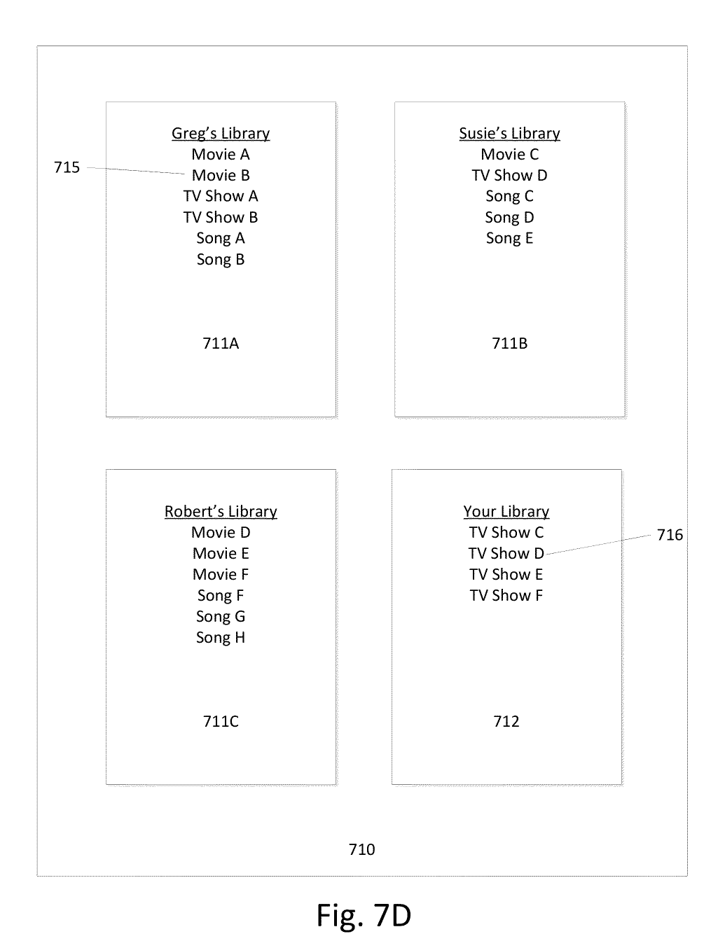

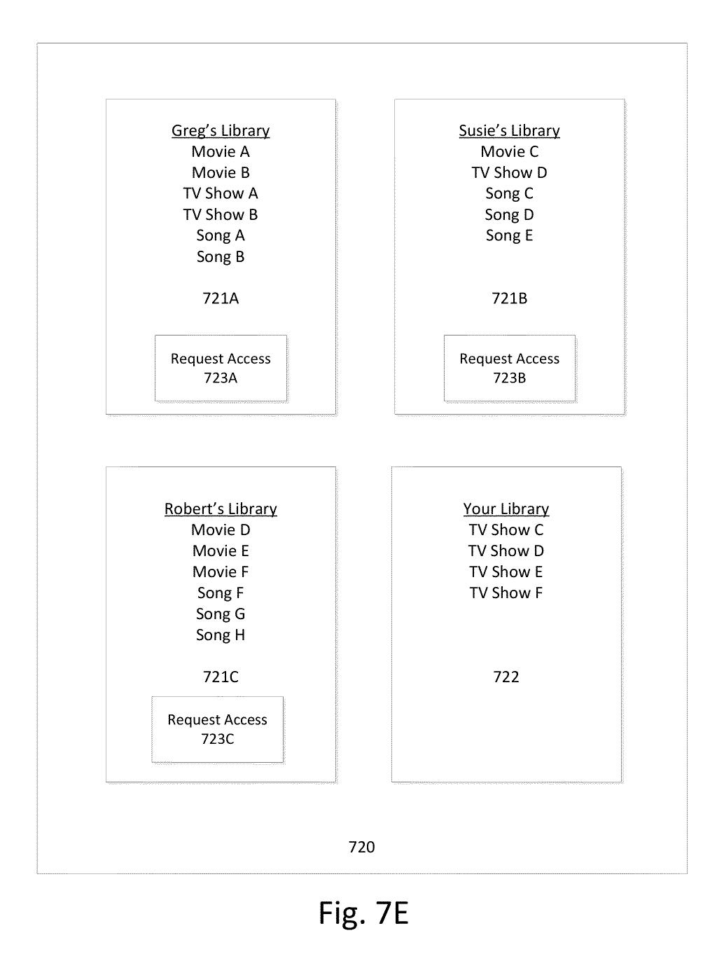

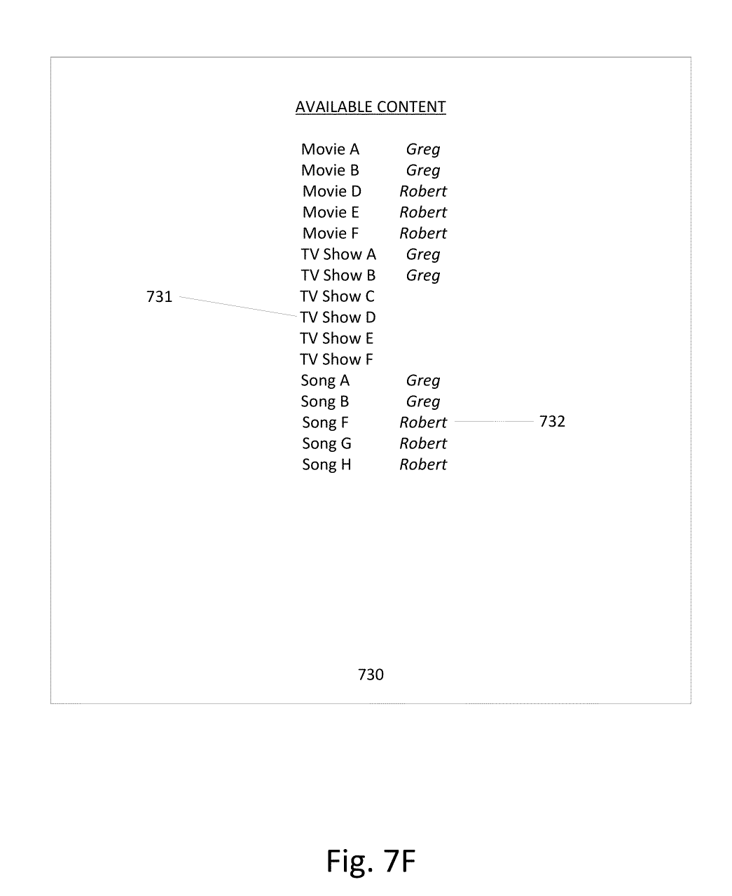

FIGS. 7A-7C illustrates an exemplary UI 700 on a user device in which a first user and second user have been authenticated and the device is authorized to be a member of a first user domain (Domain 1) and a second user domain (Domain 2). In this example, the authorization of the device to Domain 2 is temporary. The exemplary UI 700 can have three tabs including Catalog 701, Authorizations 702, and Account Manager 703. Of course, these tabs are provided for illustration only, and the UI of devices utilizing temporary authorizations can be of any type, such as the user interfaces used for different cable STBs, streaming services, subscription content, media servers, personal media devices, and the like.

In the example shown in FIG. 7A, the Catalog 701 is made up of icons (Item 1 . . . 6) that can represent content or licenses to content. The icons act in the same fashion as is well known in the art such as responding to drag and drop actions, right clicks and the like. Each icon (Item 1 . . . 6) can be associated with additional information about the icon and that the additional information can further be dynamic. For example, it is useful for the first user to know that Item 1 is a rental and that the rental is part of Domain 1. Item 1 can further include dynamic information relating to the number of days or hours left in the rental. This can be listed as part of the item, such as in Item 2, or can appear on the UI when the user performs some action, such as moving the mouse pointer over Item 1. Additionally, dynamic information can list when a user has access to a particular item of content via a temporary authorization, such as Item 3, in addition to the remaining time on a temporary authorization, such as Item 4.

Of course, other additional information can be presented to the user via the graphical interface and is not limited to only domain and rental expiration. For example, note that the Item 3 icon offers purchase and rental because Item 3 is only temporarily available through the temporary authorization. When the temporary authorization expires, Item 3 can remain available if the purchase or rent or a subscription offer is selected by the first user, otherwise the item can be removed from the UI. Alternatively, the icon can remain after the expiration of the temporary authorization, but selection of the icon can result in an offer to purchase or rent or subscribe to the content instead of providing access to the content or license. Item 5 illustrates a rental that belongs to Domain 2 and allows the user to expire it early and Item 6 illustrates purchased content.

FIG. 7B illustrates the Authorizations tab 702 according to a disclosed embodiment. Such an interface provides convenient management of authorization features for a domain such as add permanent authorization, remove permanent authorization, add temporary authorization and remove temporary authorization. The Authorizations tab 702 can enable customization of temporary authorizations such as setting the duration (15 minutes, 2 weeks, etc.) or tying a temporary authorization to a particular piece of content, type of content (music or video) or to an entire domain, for example. Users can also create temporary authorizations using the device and transfer the authorizations to other devices or portable storage for later user with a different device. Additionally, permanent authorizations can be purchased or otherwise acquired by users for content for which they can have a temporary authorization. For example, a user can have a friend enter his credentials into the device to grant a temporary authorization to a television series for which the friend has a license. If the user desires to continue watching the television series after the temporary authorization expires, he can purchase a permanent authorization for the device which allows it to continue playing the television series for which the friend has a license.

Exemplary features that can also be available via a user interface, either through the Authorizations tab 702, or through some other UI element, include device and computer registration and management. For example, the first user can edit which devices have access to content in the first content domain, which devices are permitted to access content in the second content domain via temporary authorization, and enter information to set up new devices to their content domain, such as a new mobile device or media player. Many variations of a device registration and management component are possible, and these examples are not intended to be limiting.

FIG. 7C illustrates an exemplary Account Manager tab 703 according to a disclosed embodiment. The Account Manager tab 703 can be used to support user account creation, log-in and password management for example. Additionally, the Account Manager tab 703 can be used to manage expenses, pay outstanding fees or bills due on rentals and purchases, or manage temporary authorizations linked to one or more of the user's accounts.

Of course, the user interfaces of FIGS. 7A-7C are provided for illustration only, and a variety user interfaces can be utilized with the temporary authorization technology disclosed herein. A device can be a member of multiple domains, non-temporary and temporary, and can reach out to streaming servers, local files such as Protected Interoperable File Formats (PIFF) files and the like, and can present to the user what content it can reach based upon domain authorizations that it currently has. As part of a presentation layer, the device can provide details of the rights associated with the content such as purchased, rented, domain membership, available by subscription and the like.

For example, FIG. 7D illustrates a user interface 710 that can be used to display content in a plurality of content domains. The content domains can correspond to the content libraries of other users, 711A, 711B, and 711C, and can include the user's own library 712. As shown, each content domain can be associated with a content owner. The user interface 710 can also show a plurality of content indicators, such as content indicator 715. Each content indicator represents one or more items of content and is associated with a content domain. For example, content indicator 715 represents “Movie B” and is associated with Greg's library, and content indicator 716 represents “TV Show D” and is associated with the user's library. Note that items of content can have multiple content indicators and multiple owners, such as TV Show D which is in Susie's library and the user's library.

The user can select one of the content indicators. If the user is a content owner of the content domain associated with the selected content indicator, they can be granted access to the item of content that is represented by the content indicator. For example, if the user selects content indicator 716, then they will be granted access to TV Show D since the content domain for content indicator 716 is the user's own library.

On the other hand, if the user is not a content owner of the content domain associated with the selected content indicator, a temporary authorization offer can be transmitted to the user which would grant the user temporary authorization to access the item of content represented by the selected content indicator. For example, if the user selects content indicator 715, then a temporary authorization offer can be transmitted to the user, since content indicator 715 corresponds to Movie B which is in the domain of Greg's Library and the content owner is Greg. If the user accepts the temporary authorization offer, then temporary authorization can be granted to the user to access content in the content domain associated with the selected content indicator on their device. The temporary authorization can extend to the entire domain of content, or can be for the single item that the content indicator represents. For example, the user can gain temporary authorization to access Greg's Library 711A on their device or can gain temporary authorization to access “Movie B” on their device.

The users shown in FIG. 7D can be all the users of a single device. For example, a home media storage server can store the content libraries for each of the members of the household. Alternatively, the additional users and libraries that are displayed on the user interface can be selected by the primary user of the device. For example, the user can select one or more friends or social networking contacts. The user interface can then populate with the libraries corresponding to the one or more friends.

The content owner information associated with each content domain and associated content indicator can be displayed to the user. Alternatively, the content indicators can be displayed without the content owner or content domain information.

Additionally, as shown in FIG. 7E, the user can request authorization to access an entire content domain directly. FIG. 7E shows a user interface 720 with content domains corresponding to Greg's library 721A, Susie's library 721B, Robert's library 721C, and the user's Library 722. By selecting one of the “Request Access” buttons 723A, 723B, and 723C, the user can request temporary authorization to access content in one of the content domains without having to select a specific content indicator. Of course, many variations of the user interface are possible in conjunction with the temporary authorization system disclosed herein, and the user interface is not limited to the examples disclosed.

FIG. 7F shows an interface 730 which presents an aggregate view of all content that a user has access to. For example, interface 730 includes content in a first content domain corresponding to the user's library, content in a second content domain corresponding to Greg's library, content in a third content domain corresponding to Robert's library. The user of the user interface 730 of FIG. 7F may have obtained temporary authorization to access the items of content in Greg's library of Robert's library. The user interface 730 may display content indicators, such as indicator 731 corresponding to “TV Show D” which is in the user's library. Additionally, content indicators for items of content in a content domain which has been temporarily authorized may include information identifying those items as being in the temporarily authorized content domain. For example, the content indicator for “Song F” includes information identifying that the song is part of Robert's library in the form of a “Robert” 732. Of course, the content indicators can include any of the features discussed with reference to the earlier user interfaces, such as a duration indicator which shows the time remaining for a particular temporary authorization, and other useful indicators. Additionally, the content domain that is temporarily authorized does not need to belong to a different user than the content domain that is already accessible to the device. For example, the same user may have two different accounts, and rather than logging out of one account and logging into another account, the user may acquire temporary authorization to access items of content in their second account while maintaining access to their first account.

The user interface can be used to give the user a view of all of the content that the device has access to, not just content that the user has a license for or authorization to access. The user interface can display content across multiple content domains associated with multiple content owners and provide the user options for acquiring temporary or non-temporary licenses to access the content. Additionally, special pricing models can be utilized with the present system that allows users to act as sales agents for content or to receive some incentive or reward in exchange for promoting content. For example, a user can receive a discount on the price of acquiring a temporary or non-temporary license for one or more content items in a friend's library that is visible on the user's device. Additionally, the friend can receive an incentive to promote one or more items of content that are in their library to the user or other users, such as by recommending the item. The incentive can include cash, rewards, discounts, coupons, free temporary authorizations, and the like.

A variety of trust models can be used to authorize device to content domains, ensure enforcement of copyright protection, and adhere to DRM restrictions. Rigid authentication mechanisms such as Public Key Infrastructure (PKIs) or Kerberos, for example, can be used to enable trust within a few closely collaborating domains or a single administrative domain.

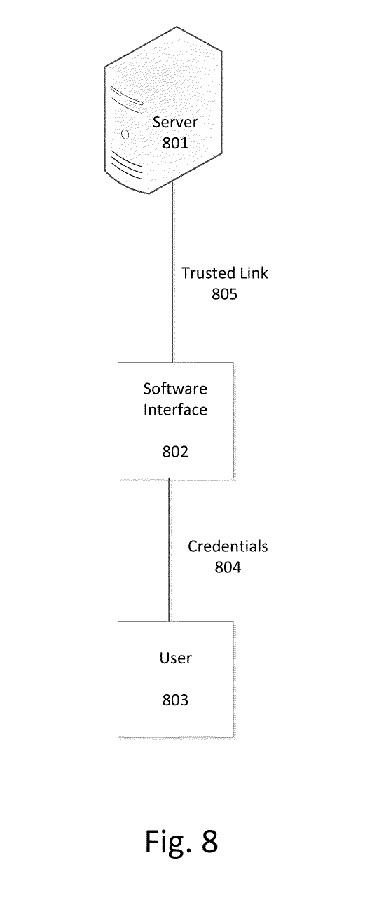

FIG. 8 illustrates an exemplary system of trust that can be used with the temporary authorization methods disclosed herein. A simplified explanation of one of the problems that such a system solves is, “Can I give you something?” Content or domain server 801 can require some sort of authentication credential check or related data or can be a simple file server. If 801 is a simple file system server, then licenses and keys are received and enforced at software interface 802. Software interface can be, for example, a browser, program, or other interface capable of communication with the Server 801 to receive and check licenses and capable of receiving data from user 803.

The software interface 802 can establish communication with server 801, acquiring keys to set up a trusted link 805. Trusted link 805 can be, for example, Secure Socket Layer (SSL), but other trusted links are also well-known and can be utilized. A user 803 with authentication credentials enters the credentials through the software interface 802 and, if accepted, the software interface 802 becomes authorized to the user 803 domain via a downloaded authorization object or conditional access scheme. Of course, the authorization object can be temporary or non-temporary.

The authorization can be part of a request for a single piece of content and the downloaded authorization object can be used to deliver a particular instance of content to the software interface 802, via stream or download, using trusted link 805 or other secure transmission means. Additionally, the authorization can result in a catalog of content being presented to the user 803 via the software interface 802.

The authorization can also result in temporary or non-temporary licenses being placed on the device hosting the software interface 802. In such a scheme the domain server 801 trusts the software interface 802 but does not trust the user 803 until the user 1103 has provided credentials 804 that the server 801 has authenticated.

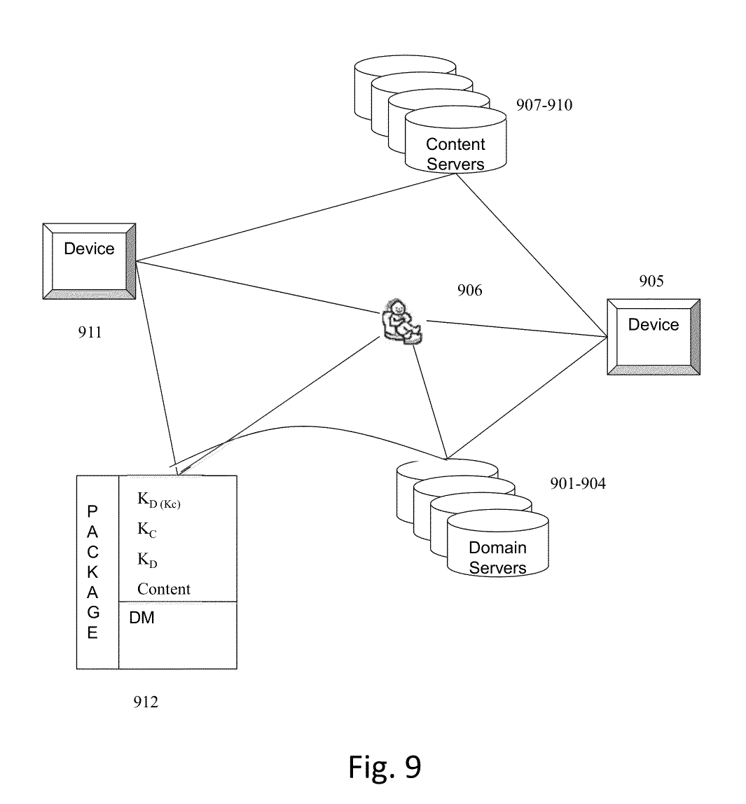

FIG. 9 shows an exemplary system of trust that relies upon content keys and domain keys. A simplified explanation of one of the problems such a system solves is, “Can I trust you to authorize non-domain devices either with or without a concurrent connection to an authorization server?” Domain servers 901 . . . 904 respond to authentication requests (logging in, checking permissions, etc.). Device 905 is a device within a first user 906 domain associated with user 906. That is, device 905 is bound to the user 906 domain. Content servers 907 . . . 910 contain encrypted content. The device 905 can become a domain member by querying and accepting user 906 authentication credentials and presenting them to any of domain servers 901 . . . 904. When one of the domain servers 901 . . . 904 accepts the credentials as authentic the device 905 is bound to the user 906 domain via a domain key K_{D}.

Domain keys can be subject to device membership counts featured by the domain and such counts can be stored in the domain servers 901 . . . 904 or on the devices 905, 911. An exemplary type of DRM system can restrict domain membership to a set number of devices at any one time. Another exemplary DRM system can define domain membership by a temporary membership scheme.

Device 905 can be a license management device. However, device 905 can also be used to access an interface to a license management service that resides in one of domain servers 901-904, cloud storage or any other storage device. For example, licenses to content can be stored as part of a web-based email account service. In such a scenario, licenses could be stored as an email object or separately as license objects. If the license is stored as an email object, for example an email receipt of purchase, the email would require a digital certificate like those provided by a certificate authority.

The license management device 905 can maintain records of an association between user 906 and usage rights to content, often as licenses, but other forms of association are contemplated. License management device 905 can also store content associated with the license.

The user 906 can provides credentials to license management device 905 which sends the credentials to one of the domain servers 901-904 for authentication (typically via SSL). If the credentials are authentic the domain servers can also check the domain restriction for the number of allowed devices in the domain. If the new authorization request would exceed the domain restriction, then the authorization server 901-904 can respond that an existing domain device should be deauthorized before the new authorization can be granted. Alternatively, the domain can be free of restrictions on the number of devices.

The domain servers or other authorizer computing systems can monitor and track temporary and non-temporary licenses for the content domains (“monitoring servers”). When a particular device activates or receives a temporary authorization, the information can be recorded and used to update the relevant monitoring servers. This allows the number of temporary authorizations to be managed and limited for each user device or user account. Additionally, the device does not need to maintain an active connection with the monitoring server in order to activate the temporary authorization once a temporary authorization is sent. For example, the device can go offline and the user can subsequently activate the temporary authorization and access an item of content. In that situation, when the device returns online, it can report that the temporary authorization was activated and utilized to the monitoring server.

If both the credentials are authenticated and the domain restrictions are not exceeded, the license management device 905 receives a domain key from the authorization server. In an exemplary trusted system, all the devices of the same domain have the same domain key. When license management device 905 has a domain key (is tethered to a domain), the key allows the user 906 to exercise the usage rights associated with content of the domain.

An exemplary DRM system can have a plurality of types of keys. For example, a first type of domain key can unlock content keys. The domain key can also have associated permissions. Permissions can be to perform license lifecycle management functions. A second type of domain key can unlock content keys but be associated with restrictions placed upon the license lifecycle management functions. For example, a user can want to temporarily share a domain key with a friend's non-domain device but not want the friend's access to include access to license lifecycle management functions and the like. Such a type of domain key could unlock a content key but also act to enforce restrictions to access of other functionality such as the ability to grant further authorizations, manage user account information and the like.

Content servers 907-910 store content. The content servers 907-910 can store unencrypted content and deliver that content over a protected link using protection such as SSL or the like. Alternatively, content servers 907-910 can store protected content that is encrypted with a content key K_{C}. Such content can be delivered any number of ways, such as via optical or flash media, stream or download using edge servers, peer-to-peer networks, super distribution and the like.

The domain and content keys associated with a temporary authorization can be stored on a device and transported to or shared among devices, for example, by loading the keys onto a portable USB memory stick. The following exemplary use case illustrates how this process would work and describes the benefits of such a feature.

When a user purchases protected content the content retailer can require credentials from the user. The retailer can use the credentials to create a user domain, authenticate the user and link the domain with a domain key K_{D}; thus enabling the user to experience the protected content across any of the authorized domain devices.

As stated earlier, all devices in the domain can have the same domain key K_{D} that is received by the device when the device becomes a domain member. Content can be encrypted with content key K_{C} and stored on the content servers 907-910. Content key K_{C} is encrypted into data E(K_{D}, K_{C}) by use of the user 906 domain key K_{D}. Herein, such data will be called the license token. When user 906 obtains access to an encrypted content, the license token E(K_{D}, K_{C}) associated with the content is also received, either together with the encrypted content or separately. One of user 906 domain devices 905 decrypts the content key K_{C} from the license token E(K_{D}, K_{C}). Because every authorized device in the domain has the domain key K_{D}, all the domain devices 905 will be able to decrypt the content key K_{C} from the license token E(K_{D}, K_{C}). Note that the content can only be used if the combination of the domain device 905, license token and encrypted content is valid, i.e., only if the user has duly acquired the license.

When the device 905 is deregistered from the user 906 domain and registered in another domain the device is no longer able to access the content belonging to the user 906 domain because the domain key K_{D} has been removed. Alternatively, the non-domain content can be removed or hidden. Or the non-domain content can be presented as an item in a catalog of content but marked as part of an unavailable domain or available via purchase, rental or subscription. Every device can be configured to have just one domain key or can be configured to have more than one domain key, as well as temporary domain keys that are subject to time limits or other restrictions such as geography, proximity and the like.

In FIG. 9, a package 912 can be stored on a transportable memory device used to move digital files among electronic devices such as a USB memory stick or SD card for example or on a device such as a PC or portable media player, phone, set-top-box, Blu-ray player or the like. Additionally, packages 912 can be transported wirelessly between devices or be stored in the cloud. In other words, a package 912 can function as a transport mechanism for authorizations and/or keys. Such a package 912 can contain a license token E(K_{D}, K_{C}) and can also contain a domain manager DM. Packages 912 can also contain the content associated with the authorization.

A package 912 can be stored in memory in the form of a USB memory stick. The package can have protected content, and a device key K_{D}, associated with a user 1206 domain, for unlocking license token E(K_{D}, K_{C}). Protected content, license token E(K_{D}, K_{C}) and device key K_{D} can be stored together or separately. The USB memory stick can be inserted into a device 911 that is not associated with the user 906 domain. For example, device 911 can be associated with another domain different from the one associated with the user 906, or not be part of any domain at all. The user can use device 911 to access content on content servers 901-904 if the content is available as part of a domain that device 911 is a member, via either streaming or download.

A user can also transport a package 912 with content, license token E(K_{D}, K_{C}) and device key KD that is part of the users domain via some sort of portable storage, for example USB memory, to a device 911 that is not a domain member. For example, the user can take a USB that contains the user's device key to a friend's house with the intent of viewing a movie the user had previously acquired authorization to on the friend's new flat screen TV. Of course, the package containing the user's device key and other keys can be transported via wired or wireless transmission from a server or another device as well. As discussed earlier, the device 911 can be a member of a different domain or not be a member of any domain. During an authorization process the device 911 (for example, the friend's TV) receives a temporary authorization via receipt of the package 912 and interaction with the user. Additionally, the temporary authorization of the device 911 to another domain can coexist with the preexisting domain. Alternatively, the device can 911 be configured so that after the temporary authorization is received, it is authorized to the temporary domain alone.

Temporary licenses in conjunction with transportable packages can enable users to carry around personal mobile repositories which contain libraries of audio/video media. Such libraries can come packaged with purchase of a phone for example, or along with a subscription to a media service for example. Using the temporary authorization technology, the content can be played on any device that is readily accessible. For example, a user staying at a hotel can connect a personal storage device containing a large library of content to the hotel TV and temporarily authorize the hotel TV for use of the content. In such a scenario, the hotel TV can be issued a temporary domain device key from the user's domain that is capable of unlocking the content keys located on the personal storage device along with the content. The temporary domain device key can be placed on the user's personal storage device at an earlier time, readily available for use anywhere, anytime and then used by the hotel TV directly so that there is no need for outside connectivity. Due to the temporary authorization, even if the content is copied locally to the hotel TV, the domain key used by the TV will expire, making the copied content unavailable.

However, when the user's domain key is transported from the user's domain to another without means to obtain content from the user's domain it is necessary to resolve the mismatch between the user's domain device key and the new domain's content keys that are encrypted with a different domain device key. For example, a user can purchase an authorization to content (a direct-to-home subscription service) and in return receive proof of authorization and a domain device key along with a temporary domain device key. The user can then store the proof of authorization and the keys on the user's phone, for example, and take a family automobile vacation. Convenience stores along the way advertise free protected content downloads to direct to home subscribers who make a purchase at the store. But an attempt to access the downloaded movie via the users Device Key will not be able to unlock the movie because the store's content keys are protected with a domain key different from the user's domain device key.

One solution to this problem is for an authorization service clearinghouse to validate or verify the user's domain and/or authorization to the content and then issue a content key protected by the user's domain device key to device 911 on a temporary basis. So, in the convenience store example, the clearinghouse can validate the user's authorization to access the content and then issue a new content key to the convenience store device, the new content key protected by the user's domain device key. That way the user's domain device keys can unlock the new content key.

Verification can comprise acceptance of the user's package, domain key, content key or interaction with the DRM system that administers the user's domain for legitimacy of the associated entitlements of the domain membership and can involve resolving the user's credentials as well. Another solution is for the user to be issued a plurality of content keys protected with domain device key.

Of course, the various features and steps relating to temporary device authorizations, license tracking, and content delivery mechanisms discussed throughout this application are not limited to the contexts in which they are discussed. Features, steps, and/or various techniques may be combined with one another in accordance with the system, method, and computer-readable media disclosed herein.

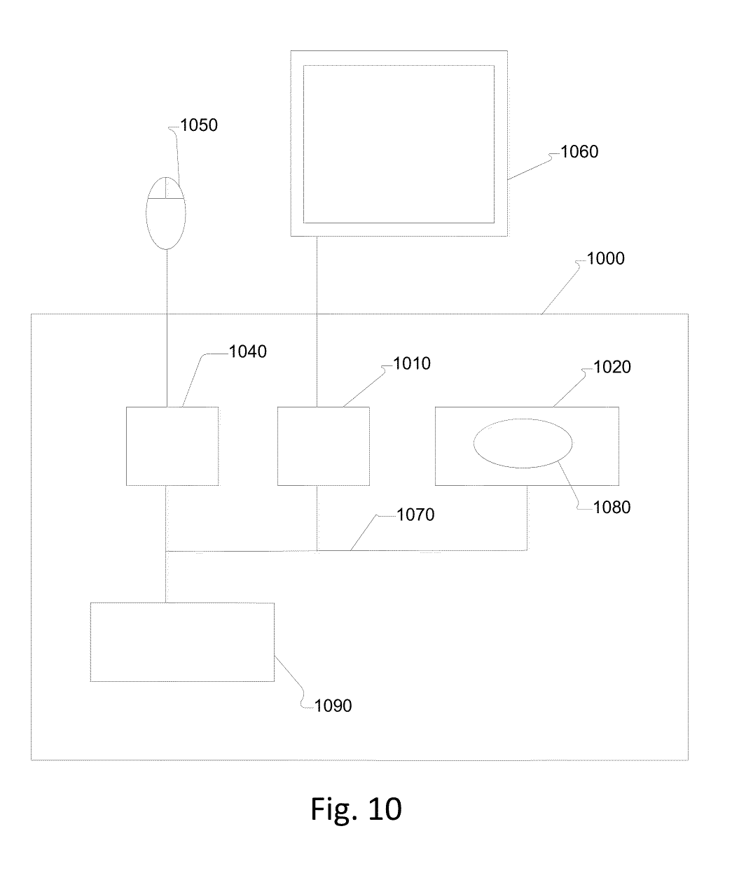

One or more of the above-described techniques can be implemented in or involve one or more computer systems. FIG. 10 illustrates a generalized example of a computing environment 1000. The computing environment 1000 is not intended to suggest any limitation as to scope of use or functionality of the described embodiment.

With reference to FIG. 10, the computing environment 100 includes at least one processing unit 1010 and memory 1020. The processing unit 1010 executes computer-executable instructions and can be a real or a virtual processor. In a multi-processing system, multiple processing units execute computer-executable instructions to increase processing power. The memory 1020 can be volatile memory (e.g., registers, cache, RAM), non-volatile memory (e.g., ROM, EEPROM, flash memory, etc.), or some combination of the two. The memory 1020 can store software 1080 implementing described techniques.

A computing environment can have additional features. For example, the computing environment 1000 includes storage 1040, one or more input devices 1050, one or more output devices 1060, and one or more communication connections 1090. An interconnection mechanism 1070, such as a bus, controller, or network interconnects the components of the computing environment 1000. Typically, operating system software or firmware (not shown) provides an operating environment for other software executing in the computing environment 1000, and coordinates activities of the components of the computing environment 1000.

The storage 1040 can be removable or non-removable, and includes magnetic disks, magnetic tapes or cassettes, CD-ROMs, CD-RWs, DVDs, or any other medium which can be used to store information and which can be accessed within the computing environment 1000. The storage 1040 can store instructions for the software 1080.

The input device(s) 1050 can be a touch input device such as a keyboard, mouse, pen, trackball, touch screen, or game controller, a voice input device, a scanning device, a digital camera, remote control, or another device that provides input to the computing environment 1000. The output device(s) 1060 can be a display, television, monitor, printer, speaker, or another device that provides output from the computing environment 1000.

The communication connection(s) 1090 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1000, computer-readable media include memory 1020, storage 1040, communication media, and combinations of any of the above.

Of course, FIG. 10 illustrates computing environment 1000, display device 1060, and input device 1050 as separate devices for ease of identification only. Computing environment 1000, display device 1060, and input device 1050 can be separate devices (e.g., a personal computer connected by wires to a monitor and mouse), can be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1000 can be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

What is claimed is:

1. An apparatus for obtaining access to content, the apparatus comprising:
one or more processors; and
one or more memories operatively coupled to at least one of the one or more processors and having instructions stored thereon that, when executed by at least one of the one or more processors, cause at least one of the one or more processors to:
transmit user credentials associated with a user of a device, wherein the device has authorization to access content in a first content domain; and
receive temporary authorization for the device to access content in a second content domain based at least in part on a determination that the user associated with the user credentials has a license to access content in the second content domain.

2. The apparatus of claim 1, wherein at least one of the one or more memories has further instructions stored thereon that, when executed by at least one of the one or more processors, cause at least one of the one or more processors to: grant temporary authorization to one or more devices which are on the same network as the apparatus, the temporary authorization allowing the one or more devices to access content in the second content domain.

3. The apparatus of claim 1, wherein the temporary authorization automatically expires on the occurrence of one or more preset conditions.

4. The apparatus of claim 3, wherein the one or more preset conditions comprise the passage of a predetermined period of time.

5. The apparatus of claim 4, wherein the predetermined period of time is defined by the user.

6. The apparatus of claim 3, wherein the one or more preset conditions comprise accessing an item of content in the second content domain.

7. The apparatus of claim 3, wherein the one or more preset conditions comprise the user moving outside of a predetermined distance from the device.

8. The apparatus of claim 1, wherein the temporary authorization grants access to a subset of the content in the second content domain.

9. The apparatus of claim 1, wherein at least one of the one or more memories has further instructions stored thereon that, when executed by at least one of the one or more processors, cause at least one of the one or more processors to: receive an offer to convert the temporary authorization to a permanent authorization.

10. The apparatus of claim 1, wherein temporary authorization is not received if a prior temporary authorization is active.

11. The apparatus of claim 1, wherein the first content domain is accessible based on a license belonging to a user other than the user associated with the user credentials.

12. The apparatus of claim 1, wherein the user credentials are transmitted in response to a request for credentials received after an attempt to access an item of content that is in the second content domain and not in the first content domain.

13. The apparatus of claim 12, wherein the temporary authorization is limited to the item of content that is in the second content domain and not in the first content domain.

14. The apparatus of claim 1, wherein receiving temporary authorization comprises receiving a temporary domain key.

15. The apparatus of claim 1, wherein, while the device has temporary authorization to access content in the second content domain, the device has authorization to access content in both the first content domain and the second content domain.

16. The apparatus of claim 1, wherein, while the device has temporary authorization to access content in the second content domain, the authorization of the device to access content in the first content domain is suspended.

17. A computer-implemented method executed by one or more computing devices for obtaining access to content, the method comprising:
transmitting, by at least one of the one or more computing devices, user credentials associated with a user of at least one of the one or more computing devices, wherein at least one of the one or more computing devices has authorization to access content in a first content domain; and
receiving, by at least one of the one or more computing devices, temporary authorization for at least one of the one or more computing devices to access content in a second content domain based at least in part on a determination that the user associated with the user credentials has a license to access content in the second content domain.

18. The computer-implemented method of claim 17, further comprising granting, by at least one of the one or more computing devices, temporary authorization to one or more additional computing devices which are on the same network as at least one of the one or more computing devices, the temporary authorization allowing the one or more additional computing devices to access content in the second content domain.

19. The computer-implemented method of claim 17, wherein the temporary authorization automatically expires on the occurrence of one or more preset conditions.

20. The computer-implemented method of claim 19, wherein the one or more preset conditions comprise the passage of a predetermined period of time.

21. The computer-implemented method of claim 20, wherein the predetermined period of time is defined by the user.

22. The computer-implemented method of claim 19, wherein the one or more preset conditions comprise accessing an item of content in the second content domain.

23. The computer-implemented method of claim 19, wherein the one or more preset conditions comprise the user moving outside of a predetermined distance from at least one of the one or more computing devices.

24. The computer-implemented method of claim 17, wherein the temporary authorization grants at least one of the one or more computing devices access to a subset of the content in the second content domain.

25. The computer-implemented method of claim 17, further comprising receiving, by at least one of the one or more computing devices, an offer to convert the temporary authorization to a permanent authorization.

26. The computer-implemented method of claim 17, wherein temporary authorization is not received if at least one of the one or more computing devices has an active prior temporary authorization.

27. The computer-implemented method of claim 17, wherein the first content domain is accessible to at least one of the one or more computing devices based on a license belonging to a user other than the user associated with the user credentials.

28. The computer-implemented method of claim 17, wherein the user credentials are transmitted in response to a request for credentials received after an attempt to access an item of content that is in the second content domain and not in the first content domain.

29. The computer-implemented method of claim 28, wherein the temporary authorization is limited to the item of content that is in the second content domain and not in the first content domain.

30. The computer-implemented method of claim 17, wherein receiving temporary authorization comprises receiving a temporary domain key.

31. The computer-implemented method of claim 17, wherein, while the at least one of the one or more computing devices has temporary authorization to access content in the second content domain, the at least one of the one or more computing devices has authorization to access content in both the first content domain and the second content domain.

32. The computer-implemented method of claim 17, wherein, while the at least one of the one or more computing devices has temporary authorization to access content in the second content domain, the authorization of the at least one of the one or more computing devices to access content in the first content domain is suspended.

33. At least one non-transitory computer-readable medium storing computer-readable instructions that, when executed by one or more computing devices, cause at least one of the one or more computing devices to:
allow access to content in a first content domain;
transmit user credentials associated with a user of a device, wherein the device has authorization to access content in a first content domain; and
receive temporary authorization for the device to access content in a second content domain based at least in part on a determination that the user associated with the user credentials has a license to access content in the second content domain.

34. The at least one non-transitory computer-readable media of claim 33, further comprising granting temporary authorization to one or more additional devices which are on the same network as at least one of the one or more computing devices, the temporary authorization allowing the one or more additional devices to access content in the second content domain.

35. The at least one non-transitory computer-readable media of claim 33, wherein the temporary authorization automatically expires on the occurrence of one or more preset conditions.

36. The at least one non-transitory computer-readable media of claim 35, wherein the one or more preset conditions comprise the passage of a predetermined period of time.

37. The at least one non-transitory computer-readable media of claim 36, wherein the predetermined period of time is defined by the user.

38. The at least one non-transitory computer-readable media of claim 35, wherein the one or more preset conditions comprise accessing an item of content in the second content domain.

39. The at least one non-transitory computer-readable media of claim 35, wherein the one or more preset conditions comprise the user moving outside of a predetermined distance from the device.

40. The at least one non-transitory computer-readable media of claim 33, wherein the temporary authorization grants access to a subset of the content in the second content domain.

41. The at least one non-transitory computer-readable media of claim 33, further comprising receiving an offer to convert the temporary authorization to a permanent authorization.

42. The at least one non-transitory computer-readable media of claim 33, wherein temporary authorization is not received if a prior temporary authorization is active.

43. The at least one non-transitory computer-readable media of claim 33, wherein the first content domain is accessible based on a license belonging to a user other than the user associated with the user credentials.

44. The at least one non-transitory computer-readable media of claim 33, wherein the user credentials are transmitted in response to a request for credentials received after an attempt to access an item of content that is in the second content domain and not in the first content domain.

45. The at least one non-transitory computer-readable media of claim 44, wherein the temporary authorization is limited to the item of content that is in the second content domain and not in the first content domain.

46. The at least one non-transitory computer-readable media of claim 33, wherein receiving temporary authorization comprises receiving a temporary domain key.

47. The at least one non-transitory computer-readable media of claim 33, wherein, while the device has temporary authorization to access content in the second content domain, the device has authorization to access content in both the first content domain and the second content domain.

48. The at least one non-transitory computer-readable media of claim 33, wherein, while the device has temporary authorization to access content in the second content domain, the authorization of the device to access content in the first content domain is suspended.
